(19) United States
(12) Patent Application Publication
(10) Pub. No.: US 2008/0230969 A1
(43) Pub. Date: Sep. 25, 2008

(54) Fluid filled type vibration damping device

(75) Inventor: Noriaki Yoshii, Nagoya-shi (JP)

Correspondence Address: OLIFF & BERRIDGE, PLC, P.O. BOX 320850, ALEXANDRIA, VA, 22320-4850, US

(73) Assignee: TOKAI RUBBER INDUSTRIES, LTD., Komaki-Shi (JP)

(21) Appl. No.: 12/073,960

(22) Filed: Mar. 12, 2008

(30) Foreign Application Priority Data
Mar. 22, 2007 (JP) 2007-073909

(51) Int. Cl. F16F 13/00

(52) U.S. Cl. 267/140.13

(57) ABSTRACT

A fluid filled type vibration damping device including a fluid filled unit having a fluid chamber sealed therein, a main rubber elastic body being a separate component from the fluid filled unit, a first mounting member affixed to the main rubber elastic body at a center section of a first end thereof. The fluid filled unit is positioned next to the other end of the main rubber elastic body with an elastic rubber wall thereof juxtaposed against the end face of the main rubber elastic body. A second mounting member is formed by including a tubular housing of the fluid filled unit with the tubular housing fastened to an outside peripheral face of the main rubber elastic body. An outside air communication passage is formed at an outside peripheral section between the juxtaposed elastic rubber wall of the fluid filled unit and the end face of the main rubber elastic body.

### INCORPORATED BY REFERENCE

The disclosure of Japanese Patent Application No. 2007-073909 filed on Mar. 22, 2007, including the specification, drawings and abstract is incorporated herein by reference in its entirety.

### BACKGROUND OF THE INVENTION

1. Field of the Invention

The present invention relates to a fluid filled type vibration damping device suitable for use as an engine mount of an automobile for example, and relates in particular to a fluid filled type vibration damping device that utilizes vibration damping action based on flow behavior of a fluid filling its interior.

2. Description of the Related Art

There are known vibration damping devices of a structure having a first mounting member attached to one member of a vibration transmission system and a second mounting member attached to the other member of the vibration transmission system, with the mounting members positioned spaced apart and connected to one another by a main rubber elastic body.

With the aim of further improving vibration damping capability, there have also been proposed fluid filled type vibration damping devices in which the interior of the vibration damping device is filled with non-compressible fluid, and vibration damping action is obtained on the based on flow behavior of the fluid filling it. According to a typical known structure for such a vibration damping device as taught in JP-A-7-71506 for example, a first mounting member is positioned spaced apart next to one opening of a second mounting member furnished with a tube portion, with the first mounting member and the second mounting member connected to one another by a main rubber elastic body. A flexible film is positioned next to the other opening of the second mounting member, and the openings of the second mounting member are fluid-tightly sealed off by the main rubber elastic body and the flexible film respectively, thereby forming between the opposed main rubber elastic body and flexible film a fluid chamber which is hermetically sealed from the outside and filled with a non-compressible fluid. The fluid chamber is bifurcated by a partition member positioned housed within the fluid chamber and supported by the second mounting member, thereby forming to one side of the partition member a primary fluid chamber that gives rise to internal pressure fluctuations during vibration input, and to the other side of the partition member a secondary fluid chamber that permits changes in volume. An orifice passage is formed connecting the primary fluid chamber with the secondary fluid chamber.

In a fluid filled type vibration damping device of this design, when jarring vibration load is input across the first mounting member and the second mounting member, noise and vibration may be produced in some instances. For example, where a fluid filled type vibration damping device of the conventional design described above is employed as an engine mount in a car, noise and vibration at a level that perceptible by the passengers of the vehicle may occur when driving over corrugated pavement for example. Such noise and vibration can pose a significant problem in cases where standards for quiet and ride comfort are high.

While the mechanism by which such noise and vibration occur is not yet sufficiently understood, extensive research and experimental results suggest that cavitation bubbles are a possible cause. Specifically, when a large jarring load is input across the first mounting member and the second mounting member, pressure within the primary fluid chamber drops, and bubbles referred to as cavitation are produced within the primary fluid chamber. It is thought that as these bubbles burst, tiny explosive “microjets” are created, and the water hammer pressure produced thereby is propagated to the first and second mounting members and thence to the vehicle body, producing problematic noise and vibration.

### SUMMARY OF THE INVENTION

It is an object of the present invention to provide a vibration damping device of novel structure whereby creation of negative pressure within the primary fluid chamber during input of jarring vibration load can be reduced or avoided, and the occurrence of noise and vibration can be suppressed.

The above and/or other objects of this invention may be attained according to at least one of the following modes of the invention. The following modes and/or elements employed in each mode of the invention may be adopted at any possible optional combinations. It is to be understood that the modes or technical features of the present invention is not limited to those described hereinafter, but may otherwise be recognized based on the thought of the present invention that described in the whole specification and drawings or that may be recognized by those skilled in the art in the light of the disclosure in the whole specification and drawings.

The present invention provides a fluid filled type vibration damping device for installation between components making up a vibration transmission system, comprising: a fluid filled unit of a structure wherein one opening of a tubular housing is sealed off by an elastic rubber wall and another opening of the tubular housing is sealed off by a flexible film, forming between opposed faces of the elastic rubber wall and the flexible film a fluid chamber filled with non-compressible fluid, and a partition member is disposed within the fluid chamber and supported by the tubular housing in order to divide the fluid chamber for forming to one side of the partition member a primary fluid chamber a portion of whose wall is defined by the elastic rubber wall, and forming to another side of the partition member a secondary fluid chamber a portion of whose wall is defined by flexible film, with the primary fluid chamber and the secondary fluid chamber interconnected by an orifice passage; a main rubber elastic body being a separate component from the fluid filled unit; a first mounting member attachable to one component of the vibration transmission system being affixed to the main rubber elastic body at a center section of a first end thereof lying in a principal vibration input direction; the fluid filled unit being positioned next to another end of the main rubber elastic body in the principal vibration input direction thereof with the elastic rubber wall of the fluid filled unit juxtaposed against an end face of the main rubber elastic body; a second mounting member attachable to another component of the vibration transmission system is formed by including the tubular housing of the fluid filled unit with the tubular housing fastened to an outside peripheral face of the main rubber elastic body; and an outside air communication passage communicating with an outside air being formed at an outside peripheral section between the juxtaposed elastic rubber wall of the fluid filled unit and the end face of the main rubber elastic body.

In the fluid filled type vibration damping device of structure according to the present invention, the elastic rubber wall which constitutes part of the wall of the primary fluid chamber is formed as a separate component from the main rubber elastic body, and the space between the elastic rubber wall and main rubber elastic body communicates with the outside (outside air) through the outside air communication passage. Thus, the elastic rubber wall and the main rubber elastic body are separably juxtaposed. With this arrangement, when jarring vibration load is input across the first mounting member and the second mounting member, inducing a high level of relative deformation of the first mounting member and the second mounting member in the direction of separation thereof, the elastic rubber wall will be induced to separate from the main rubber elastic body, thereby preventing appreciable deformation of the elastic rubber wall and reducing the drop in pressure within the primary fluid chamber that would be caused by expansion in volume of the primary fluid chamber. Thus, noise and vibration which are attributed to a pressure drop within the primary fluid chamber can be effectively reduced or avoided.

Moreover, when the first mounting member and the second mounting member undergo relative displacement in the direction urging them together, the elastic rubber wall which constitutes part of the wall of the primary fluid chamber will become juxtaposed against the main rubber elastic body, whereby elastic deformation of the main rubber elastic body will be transmitted to the elastic rubber wall and induce elastic deformation of the elastic rubber wall. Thus, the primary fluid chamber will be exposed to effective pressure fluctuations, and vibration damping action will be attained on the basis of the flow behavior of fluid through the orifice passage.

In the fluid filled type vibration damping device according to the present invention there will preferably be employed a structure whereby the second mounting member includes a fastener tube portion of tubular shape projecting further towards the outside beyond the elastic rubber wall in the fluid filled unit; and the second mounting member is non-adhesively fastened by caulking with this fastener tube portion externally girdling the main rubber elastic body.

Through non-adhesive fastening of the second mounting member to the main rubber elastic body in this way, it is possible to effectively avoid cracking of the main rubber elastic body in the portion thereof anchored to the second mounting member, where cracking can tend to be problem. Thus, improved durability on the part of the main rubber elastic body can be effectively improved.

Alternatively, in the fluid filled type vibration damping device of structure according to the present invention, it is acceptable for the second mounting member to include a main rubber outer member of tubular shape bonded to the outside peripheral wall of the other end of the main rubber elastic body in the principal vibration input direction, and to attach the fluid filled unit to the main rubber elastic body by fastening the tubular housing to the main rubber outer member.

By bonding the second mounting member to the main rubber elastic body in this way, sufficient attachment strength on the part of the second mounting member and the main rubber elastic body may be advantageously assured, and stable fastening of the second mounting member. Hence, the fluid filled unit, to the main rubber elastic body may be advantageously achieved.

Furthermore, in the fluid filled type vibration damping device of structure according to the present invention, where a structure in which the second mounting member is bonded to the main rubber elastic body as described above will be employed, the main rubber outer member may be vulcanization bonded to the main rubber elastic body.

With this arrangement, as compared to the case where the main rubber outer member is after-bonded to the main rubber elastic body, the bonding process entailed for can be eliminated making easy manufacture possible. Moreover, through vulcanization bonding, good attachment strength between the main rubber outer member and the main rubber elastic body can be achieved more advantageously.

Furthermore, in the fluid filled type vibration damping device of structure according to the present invention wherein the main rubber outer member is bonded to the main rubber elastic body, the fluid filled unit may be attached to the main rubber elastic body by fastening the tubular housing through press-fitting thereof into the main rubber outer member.

By employing a structure in which the tubular housing is fastened by press-fitting into the main rubber outer member, the fluid filled unit can be fastened easily to the main rubber elastic body side.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein:

FIG. 1 is a vertical cross sectional view of a fluid-filled type vibration damping device in the form of an automobile engine mount of construction according to a first embodiment of the present invention;

FIG. 2 is a vertical cross sectional view of an integrally vulcanization molded component of the engine mount of FIG. 1;

FIG. 3 is a vertical cross sectional view of a fluid-filled cassette of the engine mount of FIG. 1;

FIG. 4 is a vertical cross sectional view of the engine mount of FIG. 1, when being installed in position and subjected to input of jarring vibration load;

FIG. 5 is a vertical cross sectional view of a fluid-filled type vibration damping device in the form of an automobile engine mount of construction according to a second embodiment of the present invention; and

FIG. 6 is a vertical cross sectional view of an integrally vulcanization molded component of the engine mount of FIG. 5.

### DETAILED DESCRIPTION OF PREFERRED EMBODIMENTS

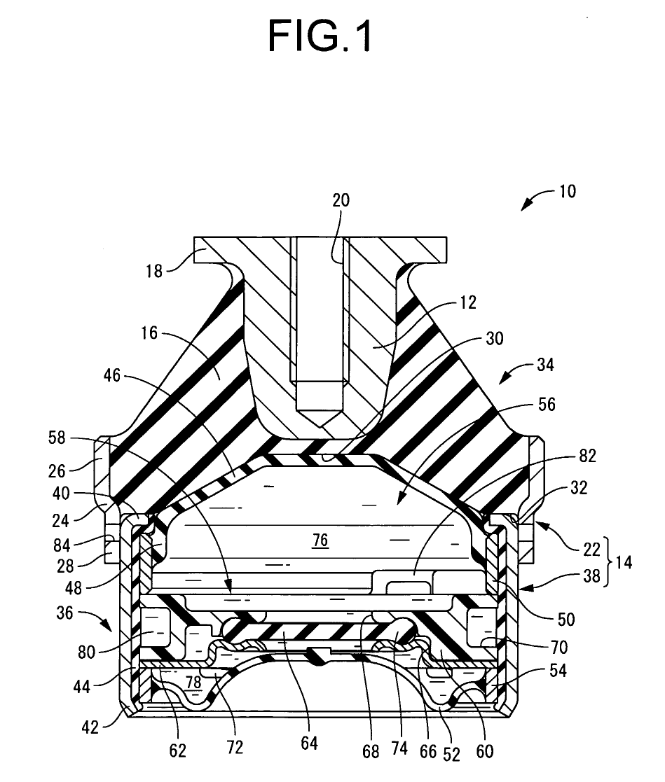

First, FIG. 1 depicts an automotive engine mount 10 by way of a first embodiment of the fluid filled type vibration damping device of the present invention. This engine mount 10 has a structure wherein a first mounting member 12 of metal for attachment to one component of a vibration transmission system, and a second mounting member 14 of metal for attachment to the other component of the vibration transmission system, are elastically connected by a main rubber elastic body 16. In the description hereinbelow, unless indicated otherwise, the vertical direction refers to the vertical direction in FIG. 1, which represents the principal load input direction in the present embodiment. FIG. 1 depicts the engine mount 10 of the present embodiment as it appears when not installed in a vehicle.

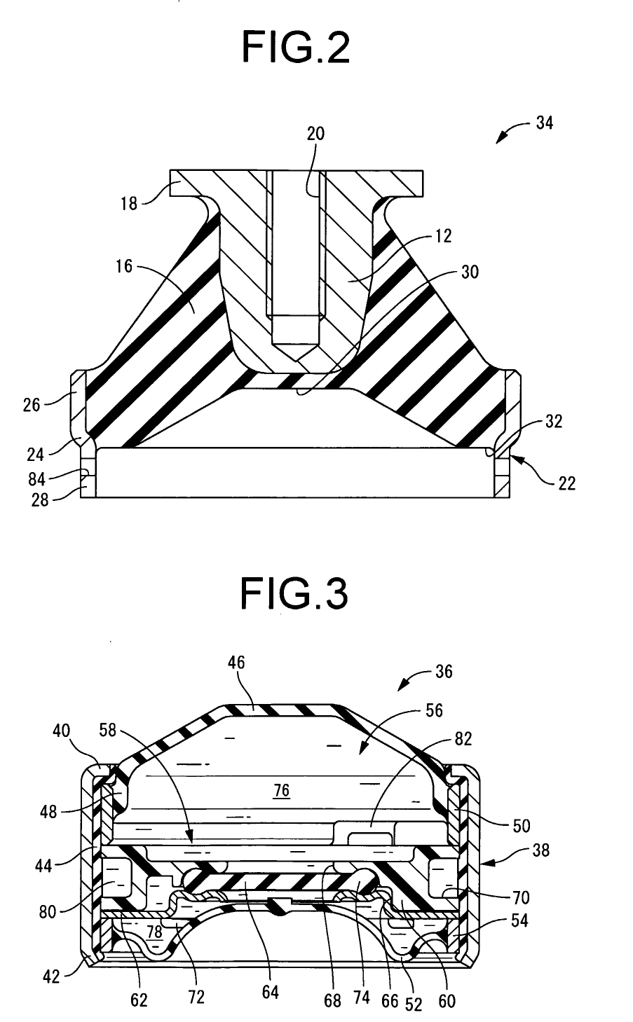

To describe in more detail, as shown in FIG. 2, the first mounting member 12 is a rigid member fabricated of iron, aluminum alloy or the like, and having a generally small-diameter, circular post shape overall. A flange portion 18 that extends towards the outer peripheral side is integrally formed at the upper edge of the first mounting member 12. Furthermore, a bolt hole 20 that extends for a prescribed distance in the axial direction is formed in the diametrical center section of the first mounting member 12, with a female thread machined on the inside peripheral face of the bolt hole 20.

Meanwhile, the second mounting member 14 includes an outer tube fitting 22 serving as a main rubber outer member. Like the first mounting member 12, the outer tube fitting 22 is formed of high-rigidity material, and has a generally large-diameter, circular tube shape extending in the axial direction. In the present embodiment, a shoulder portion 24 is formed in the approximate axial center of the outer tube fitting 22, with the side axially above the shoulder portion 24 constituting a large-diameter tube portion 26, and the side axially below constituting a small-diameter tube portion 28 smaller in diameter than the large-diameter tube portion 26.

The first mounting member 12 and the outer tube fitting 22 are positioned generally coaxially, and with the first mounting member 12 positioned spaced apart from the axial upper opening of the outer tube fitting 22. The first mounting member 12 and the outer tube fitting 22 are elastically connected together by a main rubber elastic body 16.

As shown in FIG. 2, the main rubber elastic body 16 is a rubber elastic body of generally frustoconical shape with a large-diameter center recess 30 that opens downward formed in its diametrical center section. To the outside peripheral side from the center recess 30 is formed an annular shoulder face 32 that extends in the axis-perpendicular direction.

The first mounting member 12 is embedded in and bonded by vulcanization to the center section of the upper end of the main rubber elastic body 16, which is the small-diameter end, over substantially the entirety thereof excepting the flange portion 18. The inside peripheral face of the large-diameter tube portion 26 of the outer tube fitting 22 is juxtaposed against and vulcanization bonded to the outside peripheral of the lower end of the main rubber elastic body 16, which is the large-diameter end. The first mounting member 12 and the outer tube fitting 22 are thereby connected together by the main rubber elastic body 16. As will be apparent from the above description, in the present embodiment, the main rubber elastic body 16 is formed as an integrally vulcanization molded component 34 that incorporates the first mounting member 12 and the outer tube fitting 22.

A fluid-filled cassette 36 serving as a fluid filled unit formed as a separate component from the integrally vulcanization molded component 34 is assembled together with the integrally vulcanization molded component 34 of the main rubber elastic body 16.

More specifically, as shown in FIG. 3, the fluid-filled cassette 36 is furnished with a housing fitting 38 serving as a tubular housing. The housing fitting 38 has a thin-walled, large-diameter generally round tubular shape extending in a generally straight line in the axial direction. An abutting portion 40 which curves inward in the diametrical direction is formed at the top end section of the housing fitting 38, and extends a prescribed length towards the inside peripheral side. A caulking portion 42 that slopes gradually inward as it descends is formed at the lower end of the housing fitting 38.

A seal rubber layer 44 is formed covering the inside peripheral face of the housing fitting 38. The seal rubber layer 44 is a formed by a thin rubber elastic body, and is formed so as to cover the entire inside peripheral face of the housing fitting 38. In the present embodiment, the bottom end face and the inside peripheral face of the abutting portion 40 are covered by the seal rubber layer 44 as well.

An elastic rubber wall 46 is attached to the upper end section of the housing fitting 38. The elastic rubber wall 46 is a thin rubber film with an upwardly convex, generally dome-shaped contour. The elastic rubber wall 46 has an upper surface contour that corresponds to the contour of the inside face of the center recess 30 of the main rubber elastic body 16. In the present embodiment in particular, the elastic rubber wall 46 is formed with generally unchanging thickness. A tubular anchoring portion 48 which extends in the axial direction is integrally formed on the outside peripheral edge of the elastic rubber wall 46. A fixing member 50 is anchored against the outside peripheral face of the elastic rubber wall 46. The fixing member 50 is a highly rigid member of large-diameter, generally round tubular shape. An anchoring portion 48 integrally formed on the outside peripheral edge of the elastic rubber wall 46 is vulcanization bonded to the inside peripheral face of the fixing member 50, thereby anchoring the fixing member 50 to the outside peripheral edge of the elastic rubber wall 46. In the present embodiment, the elastic rubber wall 46 takes the form of an integrally vulcanization molded component incorporating the fixing member 50.

The elastic rubber wall 46 is a separate component from the main rubber elastic body 16, and in the present embodiment will have a different rubber material composition than the main rubber elastic body 16 and the elastic rubber wall 46, depending on the qualities required of the main rubber elastic body 16 and the elastic rubber wall 46 (e.g. durability, resistance to corrosion by the sealed fluid, and so on).

A diaphragm 52 serving as a flexible film is attached to the lower end of the housing fitting 38. The diaphragm 52 is formed of a thin, generally circular disk-shaped rubber film imparted with sufficient slack and whose center section has a generally dome-shaped contour and whose outside peripheral section has rippled surface waviness. A fastener fitting 54 is anchored to the outside peripheral edge of the diaphragm 52. The fastener fitting 54 is a high-rigidity member having large-diameter, generally annular contours. In the present embodiment, the outside peripheral face of the diaphragm 52 is vulcanization bonded to the inside peripheral face of the fastener fitting 54, whereby the diaphragm 52 forms an integrally vulcanization molded component incorporating the fastener fitting 54.

The elastic rubber wall 46 and the diaphragm 52 are slipped inside the housing fitting 38, and the elastic rubber wall 46 is positioned in the upper end section of the housing fitting 38 while the diaphragm 52 is positioned in the lower end section of the housing fitting 38. The housing fitting 38 is then subjected to a diameter-reducing process such as crimping from all sides so that the diaphragm 52 and the fixing member 50 vulcanization bonded to the elastic rubber wall 46 are fastened inside the housing fitting 38.

The fixing member 50 of the elastic rubber wall 46 and the fastener fitting 54 of the diaphragm 52 are juxtaposed fluid-tightly against the housing fitting 38 via the seal rubber layer 44, whereby the upper opening of the housing fitting 38 is sealed off fluid-tightly by the elastic rubber wall 46, and the lower opening of the housing fitting 38 is sealed off fluid-tightly by the diaphragm 52. A fluid filled zone 56 constituting a fluid chamber sealed off from the outside is then formed between the axially opposed faces of the elastic rubber wall 46 and the diaphragm 52 to the inside peripheral side of the housing fitting 38. The fluid filled zone 56 is filled with a sealed fluid which is a noncompressible fluid such as water, an alkylene glycol, a polyalkylene glycol, silicone oil, a mixture of these, or the like. While the sealed fluid is not limited in any particular way, in order to advantageously achieve vibration damping action based on resonance behavior etc. of fluid induced to flow through an orifice passage 80, discussed later, it is preferable to use a low-viscosity fluid having viscosity of 0.1 Pa·s or lower. Sealing of the fluid within may be accomplished advantageously, for example, by carrying out assembly of the elastic rubber wall 46 and the diaphragm 52, as well as a partition member 58 to be discussed later, to the housing fitting 38 while these components are submerged in the fluid.

The partition member 58 is positioned housed within the fluid filled zone 56, and is supported by the housing fitting 38. The partition member 58 has a thick, generally circular disk shape overall; in the present embodiment, its structure includes a retainer fitting 62 and a movable rubber film 64 attached to a partition member main body 60.

The partition member main body 60 is a member of thick, generally circular disk shape, and in the present embodiment is fabricated of fiber-reinforced hard synthetic resin material or the like, for example. A large-diameter recess 66 is formed in the diametrical center portion of the partition member main body 60. The large-diameter recess 66 is a shallow circular recess which opens downward. A through-hole 68 is formed in the center part of the floor wall of the large-diameter recess 66. The through-hole 68 is a circular hole smaller in diameter than the large-diameter recess 66, and is formed so as to pass through the partition member main body 60 in the axial direction. A circumferential groove 70 is formed on the outside peripheral edge of the partition member main body 60. The circumferential groove 70 is a groove that extends a prescribed length in the circumferential direction, and is formed so as to open onto the outside peripheral face of the partition member main body 60.

The retainer fitting 62 is attached to the partition member main body 60. The retainer fitting 62 has a thin, generally annular disk shape, and its center section has a shouldered contour positioned above its outside peripheral section. The retainer fitting 62 is juxtaposed against the lower end face of the partition member main body 60, and several latch claws 72 which project from the lower end face of the partition member main body 60 are inserted into latch holes, not shown, which perforate the retainer fitting 62, thereby fastening it to the partition member main body 60.

The movable rubber film 64 is positioned between the opposing faces of the partition member main body 60 and the retainer fitting 62. The movable rubber film 64 is formed of a rubber elastic body having a generally circular disk shape larger in diameter than the through-hole 68 formed in the partition member main body 60. A support portion 74 is integrally formed on the outside peripheral edge of the movable rubber film 64, and extends about the entire circumference with a generally unchanging circular cross section thicker than the center portion. This movable rubber film 64 is supported with its outside peripheral edge sandwiched between the axially opposed faces of the floor wall of the large-diameter recess 66 and the center section of the retainer fitting 62, and is thereby fixedly attached to the partition member main body 60 and the retainer fitting 62. When installed, the center section of the movable rubber film 64 will be positioned so as to block off the through-hole of the retainer fitting 62, and attached in such a way that the center portion of the movable rubber film 64 is permitted to undergo displacement in the axial direction through elastic deformation.

The partition member 58 having the structure described above is assembled together with the housing fitting 38. Specifically, the partition member 58 is positioned housed to the inside peripheral side of the housing fitting 38 and situated within the fluid filled zone 56 which is formed axially between the elastic rubber wall 46 and the diaphragm 52. The partition member 58 is positioned with its upper end face juxtaposed against the lower end face of the fixing member 50 that has been vulcanization bonded to the elastic rubber wall 46, and with its lower end face juxtaposed against the upper end face of the fastener fitting 54 which has been vulcanization bonded to the diaphragm 52, and is thereby positioned sandwiched from above and below by these fittings 50, 54. The housing fitting 38 is then subjected to a diameter-reducing process such as crimping from all sides so that the outside peripheral face of the partition member 58 is crimped against the inside peripheral face of the housing fitting 38 via the seal rubber layer 44, fastening the partition member 58 inside the housing fitting 38.

In the present embodiment, the fixing member 50, the partition member 58, and the fastener fitting 54 are assembled with the housing fitting 38 at the same time. The upper edge of the fixing member 50 is disposed so as to abut from below in the axial direction the abutting portion 40 which is situated at the upper end of the housing fitting 38; and the lower edge of the fastener fitting 54 is juxtaposed in the axial direction against the caulking portion 42, so that the fixing member 50, the partition member 58, and the fastener fitting 54 are positioned between the abutting portion 40 and the caulking portion 42.

With the partition member 58 assembled in the housing fitting 38 in this way, the outside peripheral face of the partition member 58 is disposed in intimate contact against the inside peripheral face of the housing fitting 38 via the seal rubber layer 44, thereby bifurcating the fluid filled zone 56 into axially upper and lower parts situated to either side of the partition member 58. By so doing, a pressure-receiving chamber 76 a portion of whose wall is constituted by the elastic rubber wall 46 and which functions as a primary fluid chamber affected by internal pressure fluctuations during vibration input is formed to one side of the partition member 58 (the upper side in FIG. 1), while an equilibrium chamber 78 a portion of whose wall is constituted by the diaphragm 52 and which functions as a secondary fluid chamber is formed to the other side of the partition member 58 (the lower side in FIG. 1). The equilibrium chamber 78 readily permits volume change.

By placing the outside peripheral face of the partition member 58 so as to be disposed in intimate contact against the inside peripheral face of the housing fitting 38 via the seal rubber layer 44, the opening of the circumferential groove 70 which opens onto the outside peripheral face of the partition member 58 is covered fluidtightly by the housing fitting 38. A tunnel-like flow passage extending a prescribed length in the circumferential direction is formed thereby. This tunnel-like flow passage communicates at one circumferential end thereof with the pressure-receiving chamber 76 through a communication hole, not shown, formed in the partition member main body 60, and communicates at the other circumferential end thereof with the equilibrium chamber 78 through a communication hole, not shown, formed in the partition member main body 60 and the retainer fitting 62. In this way, utilizing the circumferential groove 70, the orifice passage 80 connecting the pressure-receiving chamber 76 and the equilibrium chamber 78 together is formed. In the present embodiment, the opening of the orifice passage 80 on the pressure-receiving chamber 76 end opens onto a communication projecting portion 82 which projects upward from the partition member main body 60, with the opening of the orifice passage 80 on the pressure-receiving chamber 76 end opening towards the inside peripheral side.

The orifice passage 80 in the present embodiment is tuned such that the resonance frequency of fluid induced to flow through its interior lies in a low frequency band of about 10 Hz, so as to afford effective vibration damping action against low-frequency vibration corresponding to engine shake of car or the like, on the basis of resonance etc. of the fluid induced to flow through the orifice passage 80. Tuning of the orifice passage 80 can be accomplished through proper adjustment of the ratio of passage length and passes cross sectional area of the orifice passage 80.

As shown in FIG. 1, the fluid-filled cassette 36 of the structure discussed above is assembled together with the integrally vulcanization molded component 34 of the main rubber elastic body 16 which incorporates the first mounting member 12 and the outer tube fitting 22. Specifically, the upper end section of the housing fitting 38 of the fluid-filled cassette 36 is press-fit into the small-diameter tube portion 28 of the outer tube fitting 22, thereby fastening the housing fitting 38 to the outer tube fitting 22, and attaching the fluid-filled cassette 36 to the integrally vulcanization molded component 34 so that it is positioned below the main rubber elastic body 16. In the present embodiment, the outer tube fitting 22 and the housing fitting 38 are connected and fastened together, whereby the second mounting member 14 is constituted by the outer tube fitting 22 and the housing fitting 38. In the present embodiment, the upper end face of the abutting portion 40 in the housing fitting 38 is pressed from below against the shoulder face 32 of the main rubber elastic body 16.

With the fluid-filled cassette 36 and the integrally vulcanization molded component 34 of the main rubber elastic body 16 assembled together, the elastic rubber wall 46 will be juxtaposed against the wall face of the center recess 30 formed in the main rubber elastic body 16. In the present embodiment in particular, the contour of the upper face of the elastic rubber wall 46 conforms to the contour of the wall face of the center recess 30, and thus as shown in FIG. 1, the elastic rubber wall 46 will be juxtaposed in its entirety against the end face, i.e. the face of the center recess 30 of the main rubber elastic body 16.

Here, outside air communication holes 84 are formed in the small-diameter tube portion 28 of the outer tube fitting 22. The outside air communication holes 84 are provided at multiple locations along the circumference of the outer tube fitting 22, and are formed so as to pass through the small-diameter tube portion 28 of the outer tube fitting 22 in the diametrical direction. In the present embodiment, the outside air communication holes 84 are formed such that, with the outer tube fitting 22 and the housing fitting 38 in the assembled state, their lower end is blocked off by the peripheral wall of the housing fitting 38 while their upper end is situated to the outside peripheral side of the abutting portion 40 formed at the upper end of the housing fitting 38, so that the outside air communication holes 84 are disposed with their upper end in communication with the gap between the juxtaposed faces of the housing fitting 38 and the main rubber elastic body 16.

The automotive engine mount 10 of structure according to the present embodiment is installed between a power unit and a vehicle body by means of mounting the first mounting member 12 onto the power unit, not shown, constituting one component of the vibration transmission system by means of a fastening bolt, not shown, which is threaded into the bolt hole 20, and mounting the second mounting member 14 via a bracket, not shown, onto the vehicle body, not shown, constituting the other component of the vibration transmission system, so that the power unit is supported in a vibration damped manner on the vehicle body.

With the automotive engine mount 10 installed, when vibration is input in the vertical direction, i.e. in the principal vibration input direction across the first mounting member 12 and the second mounting member 14, the desired vibration damping action will be achieved on the basis of flow behavior of the fluid inside.

Specifically, during driving of the automobile, when engine shake or other such low-frequency, large-amplitude vibration is input across the first mounting member 12 and the second mounting member 14, the elastic rubber wall 46 which is juxtaposed against the main rubber elastic body 16 will experience elastic deformation in association with elastic deformation of the main rubber elastic body 16. Pressure fluctuations will be exerted inside the pressure-receiving chamber 76 thereby, due to the elastic deformation of the elastic rubber wall 46. Thus, fluid will be induced to flow between the pressure-receiving chamber 76 and the equilibrium chamber 78 through the orifice passage 80 which has been tuned to a low-frequency range corresponding to engine shake; and vibration damping action, e.g. high attenuating action, will be effectively produced on the basis of resonance or other flow behavior of this fluid. During input of vibration in the low-frequency range, due to the large amplitude of the input vibration, hydraulic pressure absorbing action through slight elastic deformation of the movable rubber film 64 will not be produced effectively. Consequently, sufficient pressure fluctuations will be exerted on the pressure-receiving chamber 76 and fluid flow through the orifice passage 80 can be advantageously produced.

In the present embodiment in particular, the upper end face of the housing fitting 38 is pressed in the axial direction against the shoulder face 32 formed at the outside peripheral edge of the lower end face of the main rubber elastic body 16. Thus, during input of ordinary vibration to be damped, the housing fitting 38 and the main rubber elastic body 16 will be maintained in abutment with each other and the gap between the juxtaposed faces of the main rubber elastic body 16 and the elastic rubber wall 46 will be sealed off from the outside (outside air). Consequently, displacement of the main rubber elastic body 16 due to elastic deformation will be effectively transmitted to the elastic rubber wall 46, and pressure fluctuations will be exerted within the pressure-receiving chamber 76. However, this is due to the fact that where the main rubber elastic body 16 has undergone displacement in the direction away from the elastic rubber wall 46 (in the present embodiment, upward in FIG. 1), the pressure between the main rubber elastic body 16 and the elastic rubber wall 46 will drop, and the elastic rubber wall 46 will become suctioned towards the main rubber elastic body 16 side, whereby the main rubber elastic body 16 and the elastic rubber wall 46 will undergo elastic deformation in unison. Consequently, during input of vibration targeted for damping, effective vibration damping action will be produced on the basis of flow behavior of fluid flowing through the orifice passage 80, and of hydraulic pressure absorbing action by the movable rubber film 64.

In the present embodiment, the elastic rubber wall 46 has a certain thickness that is greater than the thickness of the diaphragm 52 discussed later, for example. Consequently, in the absence of vibration input, the elastic rubber wall 46 will recover its original shape due to the resilience of the elastic rubber wall 46 per se, maintaining a state of abutment between the main rubber elastic body 16 and the elastic rubber wall 46.

On the other hand, with the automobile at a stop, when medium- or high-frequency, small-amplitude vibration such as idling vibration is input across the first mounting member 12 and the second mounting member 14, pressure fluctuations exerted within the pressure-receiving chamber 76 will induce slight deformation of the movable rubber film 64. Hydraulic pressure will then be transmitted to the equilibrium chamber 78 through this slight deformation of the movable rubber film 64. Vibration damping action, e.g. low dynamic spring action, will thereby be produced on the basis of hydraulic pressure absorbing action through such slight elastic deformation of the movable rubber film 64.

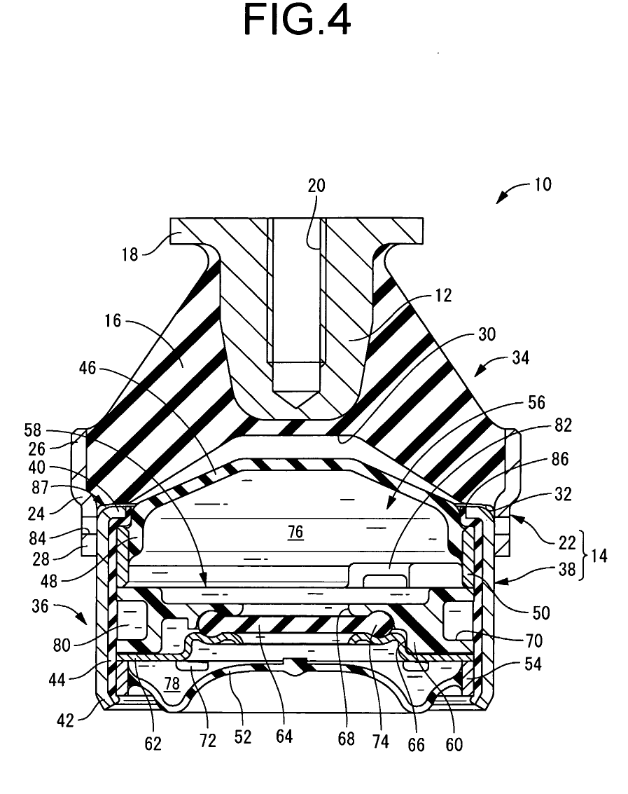

If jarring vibration load produced, for example, when the car drives over a bump is input across the first mounting member 12 and the second mounting member 14, thereby inducing the first mounting member 12 to undergo appreciable displacement axial upward relative to the second mounting member 14 and inducing the first and second mounting members 12, 14 to undergo appreciable displacement away from each other in the axial direction, the main rubber elastic body 16 will experience elastic deformation pulling it upward relative to the second mounting member 14 and inducing upward displacement of the lower end face of the main rubber elastic body 16, as shown in FIG. 4.

Here, the main rubber elastic body 16 and the fluid-filled cassette 36 are formed as separate components, and are juxtaposed against one another in a unbonded condition. Consequently, if the main rubber elastic body 16 is displaced upwardly, the shoulder face 32 formed on the outside peripheral edge of the main rubber elastic body 16 will separate from the housing fitting 38 of the fluid-filled cassette 36, forming a gap 86 between the main rubber elastic body 16 and the housing fitting 38.

Furthermore, the gap between the juxtaposed faces of the main rubber elastic body 16 and the elastic rubber wall 46 communicates with the outside air through an outside air communication passage 87 composed of the outside air communication holes 84 and the gap 86. Thus, when the main rubber elastic body 16 is displaced upwardly and separates from the elastic rubber wall 46, a drop in pressure between the juxtaposed faces of the main rubber elastic body 16 and the elastic rubber wall 46 will be prevented so that the elastic rubber wall 46 is not displaced through suction towards the main rubber elastic body 16 side. Consequently, even in the event of appreciable upward displacement of the main rubber elastic body 16 produced by input of jarring vibration load, volume expansion of the pressure-receiving chamber 76 due to partial deformation of its wall will be advantageously prevented, and the drop in pressure within the pressure-receiving chamber 76 will be limited. Therefore, the occurrence of bubbles due to the phenomenon of cavitation associated with a drop in pressure in the pressure-receiving chamber 76 can be reduced or avoided, and noise and vibration attributed to bursting of these bubbles can be advantageously prevented.

In the present embodiment, the outside air communication passage 87 communicates with outside peripheral edge portion between the opposing faces of the main rubber elastic body 16 and the elastic rubber wall 46. The gap between the opposing faces of the main rubber elastic body 16 and the elastic rubber wall 46 communicates with outside air through the outside air communication passage 87. Also, in the present embodiment, the main rubber elastic body 16 and the housing fitting 38 are pressed together in the axial direction, with the abutting force of the main rubber elastic body 16 and the housing fitting 38 being adjusted appropriately, whereby during input of jarring vibration load sufficient to cause the problem of cavitation, the main rubber elastic body 16 and the housing fitting 38 will be released from the abutting state.

Moreover, in the embodiment, the outer tube fitting 22 is vulcanization bonded to the outside peripheral face of the main rubber elastic body 16, and the housing fitting 38 is fastened by press-fitting into the outer tube fitting 22 anchored to the main rubber elastic body 16, thereby attaching the fluid-filled cassette 36 to the integrally vulcanization molded component 34 of the main rubber elastic body 16. By vulcanization bonding the outer tube fitting 22 to the main rubber elastic body 16 in advance in this way, the fluid-filled cassette 36 can be easily attached to the main rubber elastic body 16.

Furthermore, in the embodiment, the outside air communication holes 84 perforating the outer tube fitting 22 are disposed so as to communicate with the space between the abutting faces of the main rubber elastic body 16 and the housing fitting 38. Thus, during press-fitting of the housing fitting 38 into the outer tube fitting 22, air present between the housing fitting 38 and the main rubber elastic body 16 will be expelled to the outside through the outside air communication holes 84. Consequently, spring action based on elasticity of air can be prevented, and the fluid-filled cassette 36 can be attached to the integrally vulcanization molded component 34 of the main rubber elastic body 16 at the prescribed location. Accordingly, vibration damping action during input of vibration to be damped and cavitation noise suppressing action during jarring vibration input which were discussed above can both be advantageously achieved.

Moreover, the main rubber elastic body 16 and the elastic rubber wall 46 are formed as separate components; and in the present embodiment the main rubber elastic body 16 and the elastic rubber wall 46 are formed of rubber elastic bodies of different composition. Consequently, properties which are required of the main rubber elastic body 16, such as load resisting capability and attenuating capability, and properties which are required of the elastic rubber wall 46, such as corrosion resistance and sealing ability with respect to the sealed fluid, can both be realized at high levels.

In the embodiment, the fluid-filled cassette 36 is constituted as a separate component from the integrally vulcanization molded component 34 of the main rubber elastic body 16; and the elastic rubber wall 46, the partition member 58, and the diaphragm 52 are fastened to the housing fitting 38 by subjecting the housing fitting 38 to a diameter-reducing process. Meanwhile, the outer tube fitting 22, which is a separate component from the housing fitting 38, is vulcanization bonded to the main rubber elastic body 16, and the outer tube fitting 22 is subjected to a diameter-reducing process to apply pre-compression to the main rubber elastic body 16. Thus, the amount of diameter reduction of the outer tube fitting 22 and the amount of diameter reduction of the housing fitting 38 can be different; and the main rubber elastic body 16 can be imparted with a sufficient level of pre-compression without deforming the housing fitting 38 any more than necessary, to achieve the high level of load resisting capability required of the main rubber elastic body 16.

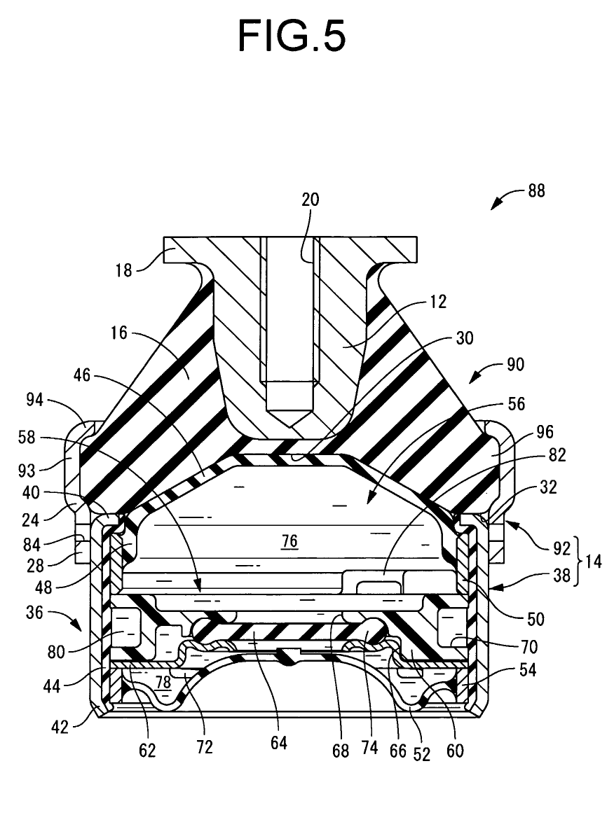

Next, an automotive engine mount 88 is shown in FIG. 5 by way of a second embodiment of the fluid filled vibration damping device according to the present invention. In the description below, components and areas substantially identical to those in the first embodiment are assigned identical symbols in the drawing and will not be discussed in any detail.

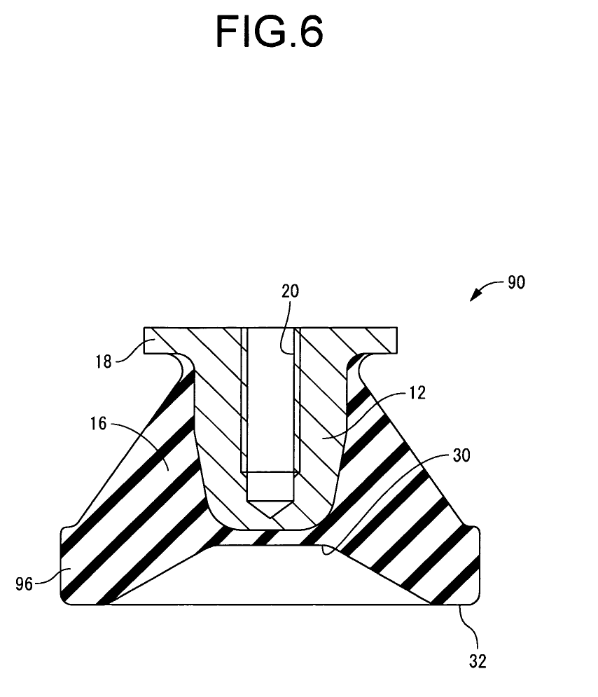

Specifically, as shown in FIG. 6, in the automotive engine mount 88 of structure according to the present embodiment, the main rubber elastic body 16 is constituted as an integrally vulcanization molded component 90 incorporating the first mounting member 12 only.

The fluid-filled cassette 36 has as a main rubber outer member an outer tube fitting 92 fastened to it and girdling it externally. The outer tube fitting 92 has generally round tubular shape extending in a straight line in the axial direction; a shoulder portion 24 is situated in its axially medial section, with the side axially above the shoulder portion 24 constituting a large-diameter tube portion 93 as a fastener tube portion, and the side axially below constituting a small-diameter tube portion 28 smaller in diameter than the large-diameter tube portion 93. In the present embodiment, a caulking piece 94 is formed at the upper end of the large-diameter tube portion 93 of the outer tube fitting 92. The caulking piece 94 is integrally formed with the large-diameter tube portion 93 by bending the upper end of the large-diameter tube portion 93 diametrically inward.

The housing fitting 38 and the outer tube fitting 92 are connected and fastened to one another by press-fitting the upper end of the housing fitting 38 into the small-diameter tube portion 28 of the outer tube fitting 92. Also, the large-diameter tube portion 93 constituting the upper end section of the outer tube fitting 92 projects upward beyond the upper edge of the housing fitting 38. In the present embodiment, the large-diameter tube portion 93 of the outer tube fitting 92 extends to a point above the upper edge of the elastic rubber wall 46.

As shown in FIG. 5, the large-diameter tube portion 93 of the outer tube fitting 92 extending upward beyond the housing fitting 38 is slipped onto the outside of the large-diameter end of the main rubber elastic body 16 and is juxtaposed against the outside peripheral face thereof, while the outside peripheral edge of the main rubber elastic body 16 is inserted axially between the shoulder portion 24 and the caulking piece 94 of the outer tube fitting 92, thereby caulk fastening the outer tube fitting 92 to the main rubber elastic body 16. In the present embodiment, a retainer portion 96 that projects towards the outside peripheral side and that includes flat surfaces extending in the axis-perpendicular direction at its upper edge face and lower edge face is disposed on the outside peripheral edge at the large-diameter end of the main rubber elastic body 16; and the outer tube fitting 92 is fastened to the main rubber elastic body 16 through support of the retainer portion 96 compressed between the opposing faces of the shoulder portion 24 and the caulking piece 94.

The large-diameter tube portion 93 of the outer tube fitting 92 is thereby fastened non-adhesively to the outside peripheral face of the large-diameter end of the main rubber elastic body 16, and the fluid-filled cassette 36 having the housing fitting 38 which is fastened to the outer tube fitting 92 is attached thereby to the main rubber elastic body 16. The second mounting member 14 in the present embodiment is constituted by the outer tube fitting 92 and the housing fitting 38, through this anchoring of the outer tube fitting 92 to the main rubber elastic body 16.

The method for installing the engine mount 88 according to the present embodiment is similar to that for the engine mount 10 in the first embodiment, and requires no discussion.

With the automotive engine mount 88 of structure according to the present embodiment as well, vibration damping action based on fluid flow through the orifice passage 80, and vibration damping effect through hydraulic pressure absorbing effect by the movable rubber film 64, will be effectively achieved. Furthermore, the effect of preventing drop in pressure within the pressure-receiving chamber 76 during input of jarring vibration load will be effectively achieved as well.

In the automotive engine mount 88 according to the present embodiment, the outer tube fitting 92 is caulk fastened to the main rubber elastic body 16, and attached non-adhesively thereby. It is therefore possible to avoid problems such as cracking of the main rubber elastic body 16 in the bonding zone of the main rubber elastic body 16 and the outer tube fitting 92, and durability of the main rubber elastic body 16 can be advantageously attained.

While the present invention has been described hereinabove in terms of certain preferred embodiments, these are merely exemplary and the present invention should in no wise be construed as limited to the specific disclosure of the embodiments herein.

For example, in the first and second embodiments, the fluid-filled cassette 36 and the integrally vulcanization molded component 34 (90) of the main rubber elastic body 16 are constituted as separate components which are then assembled together to produce the engine mount 10 (88). Accordingly, an engine mount having vibration damping characteristics different from those in the embodiments could be easily produced by attaching a fluid-filled cassette of different structure from the aforementioned first or second embodiment (e.g. a structure including both a first orifice passage tuned to a low-frequency band and a second orifice passage tuned to a medium- to high-frequency band) to an integrally vulcanization molded component 34 (90) identical in structure to those of the embodiments.

In the first and second embodiments, in the absence of vibration input the lower end face of the main rubber elastic body 16 and the upper end face of the housing fitting 38 will be positioned in abutment; and during input of jarring vibration, the main rubber elastic body 16 and the housing fitting 38 will separate from one another, the gap 86 formed thereby being utilized to form the outside air communication passage 87. However, the main rubber elastic body 16 and the upper end face of the housing fitting 38 need not be positioned in abutment in the absence of vibration input; for example, the upper end face of the housing fitting 38 may be positioned spaced axially below the lower end face of the main rubber elastic body 16, thereby deliberately forming a gap between the housing fitting 38 and the main rubber elastic body 16. Alternatively, for example, a notch could be made along at least a portion of the upper edge of the housing fitting 38 along its circumference, using the notch to deliberately forming a gap in the juxtaposed sections of the housing fitting 38 and the main rubber elastic body 16.

In the first and second embodiments, the contour of the upper face of the elastic rubber wall 46 is generally identical to the contour of the inside wall face of the center recess 30 which opens onto the lower face of the main rubber elastic body 16 so that in the absence of vibration input the main rubber elastic body 16 and the elastic rubber wall 46 are juxtaposed against one another approximately entirely. While from the standpoint of achieving reliable transmission of vibration it is preferable for the main rubber elastic body 16 and the elastic rubber wall 46 to be disposed in abutment with one another over as large an area as possible, it would be acceptable, for example, to employ a design whereby displacement of the main rubber elastic body 16 is transmitted to the elastic rubber wall 46 through localized abutment of the main rubber elastic body 16 and the elastic rubber wall 46, such as one in which the elastic rubber wall 46 shown in the first and second embodiments is positioned so that only a circular disk-shaped portion at the diametrical center thereof is disposed in abutment against the main rubber elastic body 16 and so that a tapered portion at the diametrical medial portion is separated from the main rubber elastic body 16.

It is also to be understood that the present invention may be embodied with various other changes, modifications and improvements, which may occur to those skilled in the art, without departing from the spirit and scope of the invention defined in the following claims.

What is claimed is:

1. A fluid filled type vibration damping device for installation between components making up a vibration transmission system, comprising:
a fluid filled unit of a structure wherein one opening of a tubular housing is sealed off by an elastic rubber wall and another opening of the tubular housing is sealed off by a flexible film, forming between opposed faces of the elastic rubber wall and the flexible film a fluid chamber filled with non-compressible fluid, and a partition member is disposed within the fluid chamber and supported by the tubular housing in order to divide the fluid chamber for forming to one side of the partition member a primary fluid chamber a portion of whose wall is defined by the elastic rubber wall, and forming to another side of the partition member a secondary fluid chamber a portion of whose wall is defined by flexible film, with the primary fluid chamber and the secondary fluid chamber interconnected by an orifice passage;
a main rubber elastic body being a separate component from the fluid filled unit;
a first mounting member attachable to one component of the vibration transmission system being affixed to the main rubber elastic body at a center section of a first end thereof lying in a principal vibration input direction;
the fluid filled unit being positioned next to another end of the main rubber elastic body in the principal vibration input direction thereof with the elastic rubber wall of the fluid filled unit juxtaposed against an end face of the main rubber elastic body;
a second mounting member attachable to another component of the vibration transmission system is formed by including the tubular housing of the fluid filled unit with the tubular housing fastened to an outside peripheral face of the main rubber elastic body; and
an outside air communication passage communicating with an outside air being formed at an outside peripheral section between the juxtaposed elastic rubber wall of the fluid filled unit and the end face of the main rubber elastic body.

2. The fluid filled type vibration damping device according to claim 1, wherein the second mounting member includes a fastener tube portion of tubular shape projecting further towards an outside beyond the elastic rubber wall in the fluid filled unit, and the second mounting member is non-adhesively fastened by caulking with this fastener tube portion externally girdling the main rubber elastic body.

3. The fluid filled type vibration damping device according to claim 1, wherein the second mounting member includes a main rubber outer member of tubular shape bonded to an outside peripheral wall of the other end of the main rubber elastic body in the principal vibration input direction, and the tubular housing is attached to the main rubber outer member so that the fluid filled unit is attached to the main rubber elastic body.

4. The fluid filled type vibration damping device according to claim 3, wherein the main rubber outer member is bonded by vulcanization to the main rubber elastic body.

5. The fluid filled type vibration damping device according to claim 3, wherein the tubular housing is fastened by press-fitting into the main rubber outer member so that the fluid filled unit is fastened to the main rubber elastic body.

6. The fluid filled type vibration damping device according to claim 5, wherein the main rubber outer member has an outside air communication hole perforating therethrough, and the outside air communication hole is formed such that with the main rubber outer member and the tubular housing in an assembled state, an lower end is blocked off by a peripheral wall of the tubular housing while an upper end is held in communication with a gap between the juxtaposed elastic rubber wall of the fluid filled unit and the end face of the main rubber elastic body so as to constitute the outside air communication passage.

7. The fluid filled type vibration damping device according to claim 1, wherein the main rubber elastic body and the elastic rubber wall are formed as separate components.
